(19) United States
(12) Patent Application Publication
(10) Pub. No.: US 2025/0128777 A1
(43) Pub. Date: Apr. 24, 2025

(54) DEVICE, AND CONTROL METHOD FOR VEHICLE

(71) Applicant: TOYOTA JIDOSHA KABUSHIKI KAISHA, Toyota-shi (JP)

(72) Inventors: Noritsugu Iwazaki, Sunto-gun (JP); Takeshi Kanou, Seto-shi (JP); Go Inoue, Gotemba-shi (JP); Yuki Okamoto, Ebina-shi (JP); Kento Iwahori, Nagoya-shi (JP); Jyunya Katou, Toyota-shi (JP); Amane Yajima, Ashigarakami-gun (JP)

(73) Assignee: TOYOTA JIDOSHA KABUSHIKI KAISHA, Toyota-shi (JP)

(21) Appl. No.: 18/817,568

(22) Filed: Aug. 28, 2024

(30) Foreign Application Priority Data
Oct. 20, 2023 (JP) 2023-180699

(51) Int. Cl. B62D 65/18

(52) U.S. Cl. CPC B62D 65/18

(57) ABSTRACT

A device includes: a determination unit configured to determine whether a vehicle is on a conveyor, the vehicle being configured to travel by unmanned driving; a conveyance velocity acquisition unit configured to acquire a conveyance velocity of the conveyor; and a decision unit configured to decide a target vehicle velocity of the vehicle based on the acquired conveyance velocity, when the determination unit determines that the vehicle is on the conveyor.

### CROSS-REFERENCE TO RELATED APPLICATION

This application claims priority to Japanese Patent Application No. 2023-180699 filed on Oct. 20, 2023, incorporated herein by reference in its entirety.

### BACKGROUND

### 1. Technical Field

The present disclosure relates to a device, and a control method for a vehicle.

### 2. Description of Related Art

Japanese Unexamined Patent Application Publication (Translation of PCT application) No. 2017-538619 discloses a technology in which a vehicle is caused to travel autonomously or by remote control in the manufacturing process of the vehicle.

### SUMMARY

The inventors have found that there is a possibility that the vehicle capable of traveling autonomously or by remote control travels not only on a road surface that does not move but also a conveyor that moves. A technology that makes it possible to appropriately control the traveling of the vehicle even when the vehicle travels on a conveyor is demanded.

The present disclosure can be realized as the following aspects.

A first aspect of the present disclosure is a device. The device includes: a determination unit configured to determine whether a vehicle is on a conveyor, the vehicle being capable of traveling by unmanned driving; a conveyance velocity acquisition unit configured to acquire a conveyance velocity of the conveyor; and a decision unit configured to decide a target vehicle velocity of the vehicle based on the acquired conveyance velocity, when the determination unit determines that the vehicle is on the conveyor. In this aspect, it is possible to decide an appropriate target vehicle velocity, in consideration of the conveyance velocity of the conveyor, and to appropriately control the traveling of the vehicle on the conveyor, using the decided target vehicle velocity.

The device according to the first aspect of the present disclosure may include a target velocity acquisition unit configured to acquire a first target velocity of the vehicle. The decision unit may be configured to calculate a second target velocity based on the acquired first target velocity and the acquired conveyance velocity. The decision unit may be configured to decide that the target vehicle velocity is the calculated second target velocity. With the device, it is possible to decide the target vehicle velocity based on the first target velocity.

In the device according to the first aspect of the present disclosure, the decision unit may be configured to calculate the second target velocity by subtracting the conveyance velocity from the first target velocity. With the device, it is possible to easily decide the target vehicle velocity based on the first target velocity.

The device according to the first aspect of the present disclosure may include an instruction unit configured to instruct the vehicle such that the vehicle velocity of the vehicle becomes the target vehicle velocity, when the vehicle is on the conveyor. With the device, it is possible to instruct the vehicle on the conveyor such that the traveling velocity becomes the target vehicle velocity decided in consideration of the conveyance velocity of the conveyor.

A second aspect of the present disclosure is a control method for a vehicle. The control method for the vehicle includes: determining whether the vehicle is on a conveyor, the vehicle being capable of traveling by unmanned driving; acquiring a conveyance velocity of the conveyor; and deciding a target vehicle velocity of the vehicle based on the acquired conveyance velocity, when a determination unit determines that the vehicle is on the conveyor.

A third aspect of the present disclosure is a device. The device includes a processor. The processor is configured to execute: determining whether a vehicle is on a conveyor, the vehicle being capable of traveling by unmanned driving; acquiring a conveyance velocity of the conveyor; and deciding a target vehicle velocity of the vehicle based on the acquired conveyance velocity, when determining that the vehicle is on the conveyor.

Other than the aspects as the above-described devices, the present disclosure can be realized, for example, as aspects such as a system, a program for realizing a control method for the system, a non-transitory recording medium in which the program is recorded, and a program product. For example, the program product may be provided as a recording medium in which the program is recorded, or may be provided as a program product that can be delivered through a network.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing the configuration of a system in a first embodiment;

FIG. 2 is a block diagram showing the configuration of the system in the first embodiment;

FIG. 3 is a flowchart showing a processing procedure of a traveling control for a vehicle in the first embodiment;

FIG. 4 is a flowchart showing a processing procedure of a target vehicle velocity decision process;

FIG. 5 is a block diagram showing the configuration of a system in a second embodiment; and

FIG. 6 is a flowchart showing a processing procedure of a traveling control for the vehicle in the second embodiment.

### DETAILED DESCRIPTION OF EMBODIMENTS

### A. First Embodiment

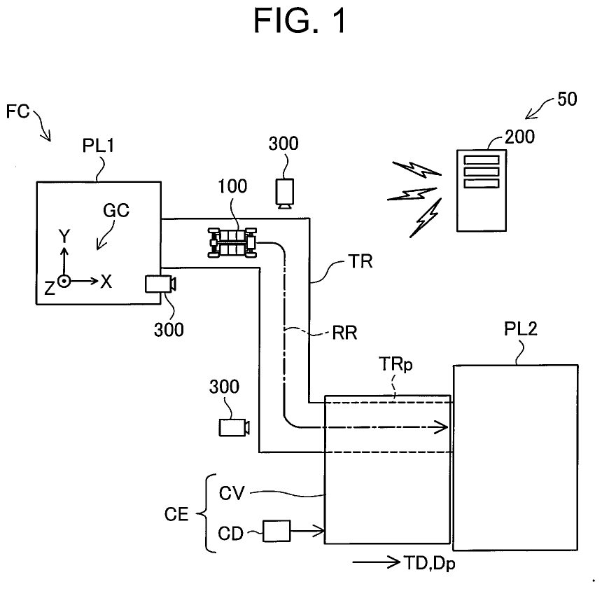

FIG. 1 is a conceptual diagram showing the configuration of a system 50 in a first embodiment. The system 50 includes one or more vehicles 100, a server 200, and one or more external sensors 300.

The vehicle 100 may be a vehicle that travels using wheels, or may be a vehicle that performs caterpillar traveling, and for example, is a passenger car, a track, a bus, a two-wheeled vehicle, a four-wheeled vehicle, a tank, a construction vehicle, and the like. In the embodiment, the vehicle 100 is a battery electric vehicle (BEV). The vehicle 100 may be a gasoline vehicle, a hybrid electric vehicle, or a fuel cell electric vehicle, for example.

The vehicle 100 is configured to be capable of traveling by unmanned driving. The “unmanned driving” means a driving that does not depend on the traveling operation by an occupant. The traveling operation means an operation relevant to at least one of “running”, “turning”, and “stopping” of the vehicle 100. The unmanned driving is realized by an automatic or manual remote control that uses a device positioned in the exterior of the vehicle 100, or by an autonomous control of the vehicle 100. An occupant that does not perform the traveling operation may ride in the vehicle 100 that travels by unmanned driving. Examples of the occupant that does not perform the traveling operation include a person that merely sits on a seat of the vehicle 100, and a person that performs, in the vehicle 100, a work different from the traveling operation, as exemplified by attachment, inspection, or the operation of switches. The driving that depends on the traveling operation by the occupant is sometimes called “manned driving”.

In the present specification, the “remote control” is a “full remote control” in which all of actions of the vehicle 100 are fully decided from the exterior of the vehicle 100, and a “partial remote control” in which some of the actions of the vehicle 100 are decided from the exterior of the vehicle 100. Further, the “autonomous control” includes a “full autonomous control” in which the vehicle 100 autonomously controls its own action without receiving information from the device in the exterior of the vehicle 100 at all, and a “partial autonomous control” in which the vehicle 100 autonomously controls its own action using information received from the device in the exterior of the vehicle 100.

The vehicle 100 only needs to have a configuration in which the vehicle 100 can move by unmanned driving, and may be a form of a platform that has a configuration described below, for example. Specifically, the vehicle 100 only needs to include at least a vehicle control device and an actuator group, which will be described later, for exerting three functions of “running”, “turning” and “stopping” by unmanned driving. In the case where information is acquired from a device in the exterior of the vehicle 100 for unmanned driving, the vehicle 100 only needs to further include a communication device. That is, the vehicle 100 that can move by unmanned driving does not need to be provided with a driver's seat and at least some of interior components such as a dashboard, does not need to be provided with at least some of exterior components such as a bumper and a fender, and does not need to be provided with a bodyshell. In this case, the other components such as the bodyshell may be attached to the vehicle 100 before the vehicle 100 is shipped from a factory FC, or the other components such as the bodyshell may be attached to the vehicle 100 after the vehicle 100 is shipped from the factory FC in a state where the other components such as the bodyshell have not been attached to the vehicle 100. Components may be attached from arbitrary directions such as the upper side, lower side, front side, rear side, right side, and left side of the vehicle 100, and may be attached from the same direction as each other, or may be attached from different directions from each other.

In the embodiment, the system 50 is used in the factory FC where the vehicle 100 is manufactured. The reference coordinate system of the factory FC is a global coordinate system GC. That is, an arbitrary position in the factory FC is expressed as X-Y-Z coordinates in the global coordinate system GC. The factory FC includes a first place PL1 and a second place PL2. The first place PL1 and the second place PL2 are connected by a traveling road TR along which the vehicle 100 can travel. In the factory FC, a plurality of external sensors 300 is installed along the traveling road TR. The positioning of each external sensor 300 in the factory FC is previously performed. The vehicle 100 moves on the traveling road TR from the first place PL1 to the second place PL2 by unmanned driving. In the embodiment, the vehicle 100 has a form of a platform in a period during which the vehicle 100 moves from the first place PL1 to the second place PL2. In another embodiment, the vehicle 100 may have a form of a completed vehicle, without being limited to the form of a platform.

In the embodiment, a partial traveling road TRp that is a part of the traveling road TR is constituted by a part of a conveyor CV built in the factory FC. The conveyor CV is included in a conveyor device CE. The conveyor CV is driven by a conveyor drive unit CD that is included in the conveyor device CE. For example, the conveyor CV is configured as a belt conveyor including an endless belt for conveyance, a chain conveyor including an endless chain for conveyance, and a roller conveyor including a roller for conveyance. For example, the conveyor drive unit CD is constituted by a motor for generating drive force and a transmission mechanism for transmitting the drive force of the motor to the conveyor CV, as exemplified by a gear and a pulley. For example, the conveyor drive unit CD is driven under the control by the server 200 or another computer (not illustrated) different from the server 200. The conveyor device CE can convey an arbitrary conveyed object, as exemplified by various components, humans, and various vehicles that are not being driven, while moving the vehicle 100 on the conveyor CV. In this case, it is preferable that the conveyor device CE convey the conveyed object at a portion on the conveyor CV that is different from the partial traveling road TRp.

In the embodiment, a conveyance direction TD of the conveyor CV is the same direction as a target direction Dp of the vehicle 100 on the partial traveling road TRp. The target direction Dp means the moving direction of the vehicle 100 along a later-described reference route RR. That is, the target direction Dp is a direction in which the vehicle 100 moves from a rearward side to a forward side on the reference route RR. Specifically, each of the conveyance direction TD and the target direction Dp in the embodiment is the +X direction. Various work processes may be executed to the vehicle 100 that moves on the conveyor CV. Examples of the work process include a process of attaching a component to the vehicle 100 and a process of inspecting parts of the vehicle 100. For example, the work process for the vehicle 100 on the conveyor CV may be executed by a worker or a robot that is on the vehicle 100 or the conveyor CV, or may be executed by a worker or a robot that is not on the conveyor CV. Further, the above work process may be executed to the vehicle 100 that travels at a portion that is of the traveling road TR and that is not on the conveyor CV, that is, at a portion that is different from the partial traveling road TRp. In this case, for example, the work process may be executed by a worker or a robot that is on the vehicle 100, or may be executed by a worker or a robot that is not on the vehicle 100.

The actual velocity of the vehicle 100 that moves on the conveyor CV is determined depending on the vehicle velocity of the vehicle 100 and the conveyance velocity of the conveyor CV. In the present specification, the “vehicle velocity” means the relative velocity of the vehicle 100 to the road surface where the vehicle 100 is positioned. This road surface includes not only a stationary road surface but also a moving road surface such as the conveyor CV. As described later, the vehicle velocity can be detected based on a value indicating the rotation speed of the wheel. Further, in the present specification, the “actual velocity” means an absolute velocity in the reference coordinate system. That is, the actual velocity of the vehicle 100 in the embodiment is the absolute velocity of the vehicle 100 in the global coordinate system GC. For example, in the case where the conveyance velocity of the conveyor CV has a velocity component that has the same direction as the moving direction of the vehicle 100, the actual velocity of the vehicle 100 that moves on the conveyor CV is higher than the vehicle velocity of the vehicle 100, depending on the conveyance velocity of the conveyance CV. Specifically, in this case, when the idling and slipping of the wheel are not considered, the actual velocity of the vehicle 100 roughly coincides with a velocity resulting from adding, to the vehicle velocity, the magnitude of a velocity component that is of the conveyance velocity and that has the same direction as the moving direction. Conversely, in the case where the conveyance velocity of the conveyor CV has a velocity component that has the opposite direction of the traveling direction of the vehicle 100, the actual velocity of the vehicle 100 that moves on the conveyor CV is lower than the vehicle velocity of the vehicle 100, depending on the conveyance velocity of the conveyor CV. Specifically, in this case, when the idling and slipping of the wheel are not considered, the actual velocity of the vehicle 100 roughly coincides with a velocity resulting from subtracting, from the vehicle velocity, the magnitude of a velocity component that is of the conveyance velocity and that has the opposite direction of the moving direction. Further, the actual velocity of the vehicle 100 that travels on the stationary road surface roughly coincides with the vehicle velocity, when the idling and slipping of the wheel are not considered.

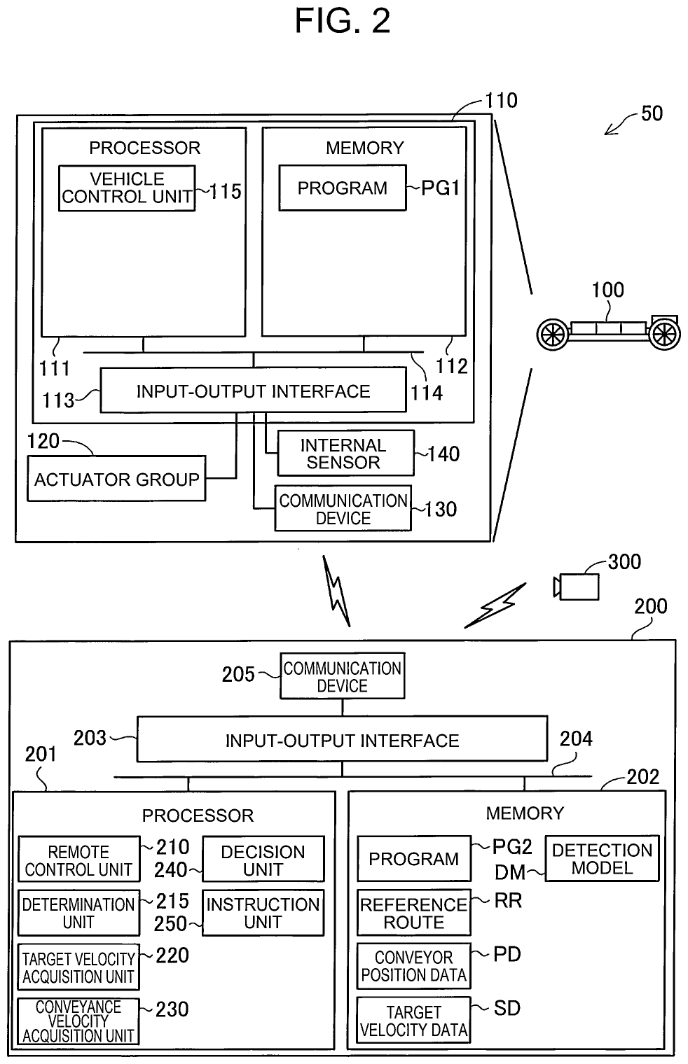

FIG. 2 is a block diagram showing the configuration of the system 50. The vehicle 100 includes a vehicle control device 110 for controlling parts of the vehicle 100, an actuator group 120 that is driven under the control by the vehicle control device 110 and that includes one or more actuators, a communication device 130 for communicating with external devices such as the server 200, by wireless communication, and one or more internal sensors 140. The actuator group 120 includes actuators relevant to the traveling of the vehicle 100, as exemplified by an actuator of a drive device for accelerating the vehicle 100, an actuator of a steering device for changing the moving direction of the vehicle 100, and an actuator of a braking device for decelerating the vehicle 100. The drive device includes a battery, a traveling motor that is driven by the electric power of the battery, and drive wheels that are rotated by the traveling motor. The actuator of the drive device includes the traveling motor.

The internal sensor 140 is a sensor that is equipped in the vehicle 100. Examples of the internal sensor 140 can include a sensor that detects the motion state of the vehicle 100, a sensor that detects the operating state of each part of the vehicle 100, and a sensor that detects the environment around the vehicle 100. In the embodiment, the internal sensor 140 includes a vehicle velocity sensor that detects the vehicle velocity of the vehicle 100. The vehicle velocity sensor detects the vehicle velocity based on the value indicating the rotation speed of the wheel included in the vehicle 100 and the diameter of the wheel. As the value indicating the rotation speed of the wheel, for example, the rotation speed of the traveling motor included in the vehicle 100 may be used, the rotation speed of an output shaft may be used, or the rotation speed of the wheel that is acquired by a wheel velocity sensor may be used. In addition to the vehicle velocity sensor and the wheel velocity sensor, examples of the internal sensor 140 can include a camera, a light detection and ranging (LiDAR), a millimeter-wave radar, an ultrasonic sensor, a GPS sensor, an acceleration sensor, a gyroscope sensor, and the like.

The vehicle control device 110 is constituted by a computer including a processor 111, a memory 112, an input-output interface 113, and an internal bus 114. The processor 111, the memory 112, and the input-output interface 113 are connected through the internal bus 114, in a bi-directionally communicable manner. The input-output interface 113 is connected with the actuator group 120 and the communication device 130. The processor 111 executes a program PG1 stored in the memory 112, and thereby, realizes various functions including a function as a vehicle control unit 115.

The vehicle control unit 115 causes the vehicle 100 to travel by controlling the actuator group 120. The vehicle control unit 115 can cause the vehicle 100 to travel, by controlling the actuator group 120 using a traveling control signal received from the server 200. The traveling control signal is a control signal for causing the vehicle 100 to travel. In the embodiment, the traveling control signal includes the acceleration and steering angle of the vehicle 100, as parameters. In another embodiment, the traveling control signal may include the vehicle velocity of the vehicle 100 as a parameter, instead of or in addition to the acceleration of the vehicle 100.

The external sensor 300 is a sensor that is positioned in the exterior of the vehicle 100. The external sensor 300 in the embodiment is a sensor that catches the vehicle 100 from the exterior of the vehicle 100. Specifically, the external sensor 300 is constituted by a camera. The camera as the external sensor 300 acquires a pickup image including the vehicle 100, and outputs the pickup image as a detection result. The external sensor 300 includes a communication device (not illustrated), and can communicate with other devices such as the server 200 by wire communication or wireless communication.

The server 200 is constituted by a computer including a processor 201, a memory 202, an input-output interface 203, and an internal bus 204. The processor 201, the memory 202, and the input-output interface 203 are connected through the internal bus 204, in a bi-directionally communicable manner. The input-output interface 203 is connected with a communication device 205 for communicating with various devices in the exterior of the server 200. The communication device 205 can communicate with the vehicle 100 by wireless communication, and can communicate with each external sensor 300 by wire communication or wireless communication. In the memory 202, a variety of information including a program PG2, a reference route RR, a detection model DM, conveyor position data PD, and target velocity data SD is stored. The processor 201 executes the program PG2 stored in the memory 202, and thereby, realizes various functions including functions as a remote control unit 210, a determination unit 215, a target velocity acquisition unit 220, a conveyance velocity acquisition unit 230, a decision unit 240, and an instruction unit 250. The server 200 in the first embodiment is an example of the “device” in the present disclosure.

The remote control unit 210 acquires detection results of sensors, generates a traveling control signal for controlling the actuator group 120 of the vehicle 100 using the detection results, and causes the vehicle 100 to travel by remote control, by sending the traveling control signal to the vehicle 100. In addition to the traveling control signal, the remote control unit 210 may generate and output control signals for controlling actuators that operate a variety of auxiliary machines included in the vehicle 100 and a variety of equipment such as a wiper, a power window, and a lamp, for example. That is, the remote control unit 210 may operate a variety of auxiliary machines and a variety of equipment by remote control.

The determination unit 215 determines whether the vehicle 100 is on the conveyor CV. As described later, in the embodiment, the determination unit 215 determines whether the vehicle 100 is on the conveyor CV, using the pickup image that is acquired by the camera as the external sensor 300. The determination unit 215 may determine that the vehicle 100 is on the conveyor CV, when the determination unit 215 detects that all wheels included in the vehicle 100 are on the conveyor CV, or may determine that the vehicle 100 is on the conveyor CV, when the determination unit 215 detects that some wheels of the wheels included in the vehicle 100 are on the conveyor CV. For example, in the case where the vehicle 100 is a four-wheeled vehicle, the determination unit 215 determines that the vehicle 100 is on the conveyor CV, when the determination unit 215 detects that the wheels on the front side in the moving direction of the vehicle 100 are on the conveyor CV, or may determine that the vehicle 100 is on the conveyor CV, when the determination unit 215 detects that the four wheels are on the conveyor CV. The wheels on the front side in the moving direction of the vehicle 100 are the front wheels in the case where the vehicle 100 moves forward, and are the rear wheels in the case where the vehicle 100 moves rearward. Further, in another embodiment, the determination unit 215 may determine whether the vehicle 100 is on the conveyor CV, for example, using an area sensor that detects that the vehicle 100 has entered a region where the conveyor CV has been built, or a sensor that detects an external force or pressure given to the conveyor CV.

The target velocity acquisition unit 220 acquires a first target velocity of the vehicle 100. The target velocity acquisition unit 220 acquires the first target velocity that is previously stored in the memory 202. In the embodiment, the first target velocity is included in the target velocity data SD that is previously stored in the memory 202. In another embodiment, for example, the target velocity acquisition unit 220 may acquire the first target velocity from another computer, a recording medium, or the like in the exterior of the server 200.

In the embodiment, the first target velocity is defined as an actual velocity that is targeted for the vehicle 100. Specifically, the first target velocity is an actual velocity that is targeted for the vehicle 100 that moves in the target direction Dp. It is preferable that the first target velocity be so high that increase in cycle time can be restrained, for example. Further, in the case where a work process by a worker, a robot, or the like that is not on the conveyor CV is executed to the vehicle 100 on the conveyor CV, it is preferable that the first target velocity be so low that the accuracy in the work process does not decrease due to the speed of the movement of the vehicle 100, for example. Further, in the case where a work process by a worker, a robot, or the like that is on the conveyor CV or the vehicle 100 is executed to the vehicle 100 on the conveyor CV, it is preferable that the first target velocity be so low that the work process can be completed when the vehicle 100 is moving within a previously set range on the conveyor CV, for example.

In the embodiment, the target vehicle velocity of the vehicle 100 on a portion that is of the traveling road TR and that is different from the partial traveling road TRp is set to the same velocity as the first target velocity. That is, in the embodiment, the actual velocity that is targeted for the vehicle 100 on the traveling road TR is the same velocity as the first target velocity, regardless of whether the vehicle 100 is on the conveyor CV.

In another embodiment, for example, the first target velocity may be variable depending on the manufacturing situation of the vehicle 100 in the factory FC. In this case, for example, the server 200 or another computer may decide the first target velocity depending on the manufacturing situation. Further, different first target velocities may be set depending on the position of the conveyor CV in the target direction Dp. For example, in the case where a first work and a second work are respectively executed in a first range and a second range on the partial traveling road TRp in the target direction Dp, a first target velocity suitable for the first work may be set for the first range, and a first target velocity suitable for the second work may be set for the second range. Further, for example, the first target velocity may be temporarily set to zero. Further, for example, the system 50 may accept the input of the first target velocity from a user (for example, an administrator of the system 50) of the system 50, through an input device that is provided in the server 200, another computer, or the like.

The conveyance velocity acquisition unit 230 acquires the conveyance velocity of the conveyor CV. For example, the conveyance velocity acquisition unit 230 acquires the conveyance velocity of the conveyor CV, using various sensors for detecting the movement of the conveyor CV. For example, the conveyance velocity acquisition unit 230 may acquire the conveyance velocity of the conveyor CV, using a potentiometer or an encoder that is provided in the conveyor device CE. The potentiometer or the encoder is not limited to a sensor that directly detects the movement of the conveyer CV, and may be constituted by a sensor that detects the rotation speed of the motor or transmission mechanism included in the conveyor drive unit CD, for example. Further, for example, the conveyance velocity acquisition unit 230 may acquire the conveyance velocity of the conveyor CV, using a camera that can pick up the image of the conveyor CV. In this case, for example, a marker may be previously given to the conveyor CV, and the conveyance velocity acquisition unit 230 may acquire the conveyance velocity of the conveyor CV based on the change of the position of the marker in the pickup image by the camera. Further, in the embodiment, the external sensor 300 may be used as the camera for acquiring the conveyance velocity of the conveyor CV.

When it is determined that the vehicle 100 is on the conveyor CV, the decision unit 240 decides the target vehicle velocity of the vehicle 100 based on the acquired conveyance velocity. In the embodiment, the decision unit 240 calculates a second target velocity of the vehicle 100, based on the acquired conveyance velocity and the acquired first target velocity, and decides that the target vehicle velocity is the calculated second target velocity. The instruction unit 250 instructs the vehicle 100 on the conveyor CV such that the traveling velocity of the vehicle 100 becomes the second target velocity.

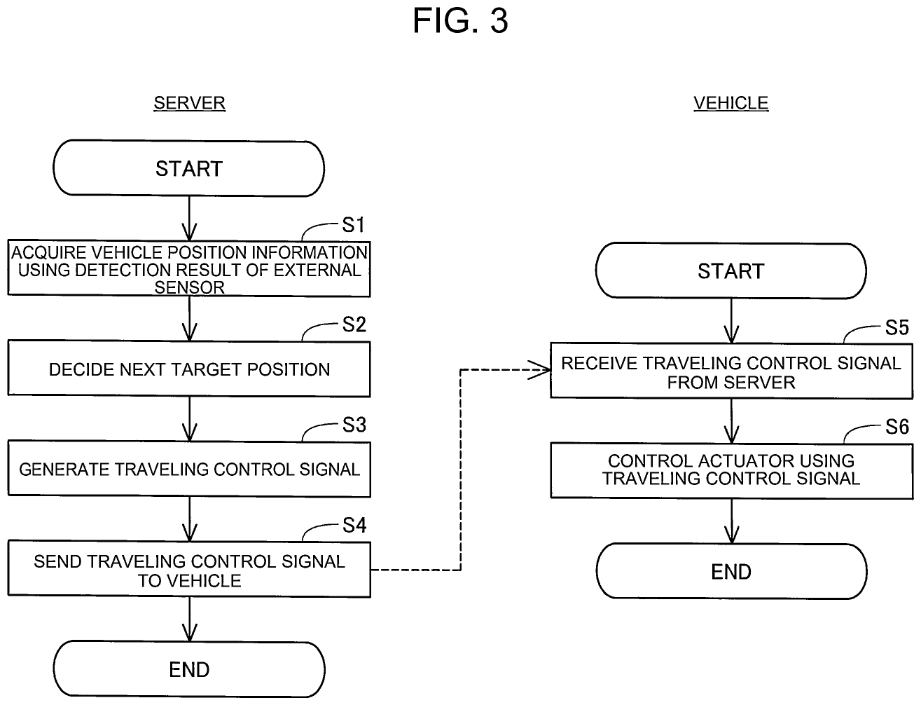

FIG. 3 is a flowchart showing a processing procedure of a traveling control for the vehicle 100 in the first embodiment. In the processing procedure in FIG. 3, the processor 201 of the server 200 functions as the remote control unit 210, by executing the program PG2. Further, the processor 111 of the vehicle 100 functions as the vehicle control unit 115, by executing the program PG1.

In step S1, the processor 201 of the server 200 acquires vehicle position information about the vehicle 100, using the detection result that is output from the external sensor 300. The vehicle position information is position information from which the traveling control signal is generated. In the embodiment, the vehicle position information includes the position and orientation of the vehicle 100 in the global coordinate system GC of the factory FC. Specifically, in step S1, the processor 201 acquires the vehicle position information using the pickup image acquired from the camera that is the external sensor 300.

More specifically, in step S1, the processor 201 acquires the position of the vehicle 100, for example, by detecting the outer shape of the vehicle 100 from the pickup image, calculating the coordinates of a position measurement point of the vehicle 100 in a coordinate system for the pickup image, that is, in a local coordinate system, and converting the calculated coordinates into coordinates in the global coordinate system GC. For example, the outer shape of the vehicle 100 included in the pickup image can be detected by inputting the pickup image to the detection model DM that utilizes an artificial intelligence. For example, the detection model DM is prepared in the interior of the system 50 or in the exterior of the system 50, and is previously stored in the memory 202 of the server 200. Examples of the detection model DM include a machine learning model after learning for which learning has been performed such that one of semantic segmentation and instance segmentation is realized. As the machine learning model, for example, a convolutional neural network (referred to as a CNN, hereinafter) for which learning has been performed by a supervised learning using a learning data set can be used. For example, the learning data set includes a plurality of training images that includes the vehicle 100, and labels each of which indicates whether a region in the training image is a region for the vehicle 100 or a region other than that for the vehicle 100. At the time of the learning for the CNN, it is preferable to update parameters in the CNN so as to reduce the error between the output result by the detection model DM and the label, by a back propagation method. Further, for example, the processor 201 can acquire the orientation of the vehicle 100, by estimating the orientation of the vehicle 100 based on the orientation of the mobile vector of the vehicle 100 that is calculated from the position change in the feature point of the vehicle 100 among frames of the pickup image, using an optical flow method.

In step S2, the processor 201 of the server 200 decides a next target position to which the vehicle 100 will go. In the embodiment, the target position is expressed as X-Y-Z coordinates in the global coordinate system GC. The reference route RR that is a route along which the vehicle 100 will travel is previously stored in the memory 202 of the server 200. The route is shown by a node indicating a departure place, nodes indicating pass points, a node indicating a destination, and links connecting nodes. The processor 201 decides the next target position to which the vehicle 100 will go, using the vehicle position information and the reference route RR. The processor 201 decides the target position on the reference route RR ahead of the current position of the vehicle 100.

In step S3, the processor 201 of the server 200 generates the traveling control signal for causing the vehicle 100 to travel to the decided target position. The processor 201 acquires the vehicle velocity from the vehicle 100, and compares the acquired vehicle velocity and the target vehicle velocity. As a whole, the processor 201 decides the acceleration such that the vehicle 100 is accelerated when the vehicle velocity is lower than the target vehicle velocity, and decides the acceleration such that the vehicle 100 is decelerated when the vehicle velocity is higher than the target vehicle velocity. Further, when the vehicle 100 is positioned on the reference route RR, the processor 201 decides the steering angle and the acceleration such that the vehicle 100 does not depart from the reference route RR. When the vehicle 100 is not positioned on the reference route RR, in other words, when the vehicle 100 has departed from the reference route RR, the processor 201 decides the steering angle and the acceleration such that the vehicle 100 returns to the reference route RR.

In step S4, the processor 201 of the server 200 sends the generated traveling control signal to the vehicle 100. The processor 201 repeats the acquisition of the vehicle position information, the decision of the target position, the generation of the traveling control signal, the sending of the traveling control signal, and the like, in a predetermined cycle.

In step S5, the processor 111 of the vehicle 100 receives the traveling control signal sent from the server 200. In step S6, the processor 111 of the vehicle 100 controls the actuator group 120 using the received traveling control signal, and thereby, causes the vehicle 100 to travel at the acceleration and steering angle that are shown in the traveling control signal. The processor 111 repeats the receiving of the traveling control signal and the control of the actuator group 120, in a predetermined cycle. With the system 50 in the embodiment, it is possible to cause the vehicle 100 to travel by remote control, and to move the vehicle 100 without using conveyance equipment such as a crane or a conveyor.

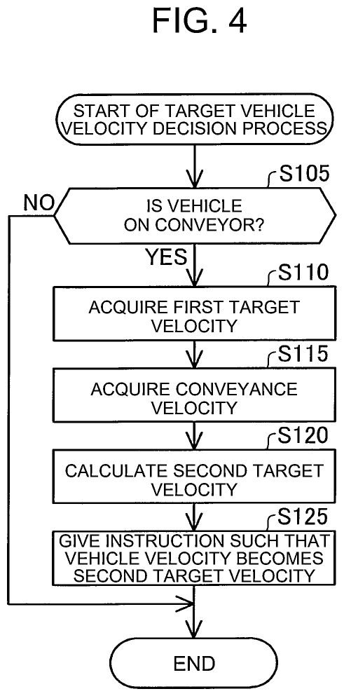

FIG. 4 is a flowchart showing a processing procedure of a target vehicle velocity decision process for realizing the control method for the vehicle 100 in the embodiment. The target vehicle velocity decision process in FIG. 4 is executed by the processor 201 of the server 200, at a predetermined time interval, for example.

In step S105, the determination unit 215 determines whether the vehicle 100 is on the conveyor CV. In step S105 in the embodiment, the determination unit 215 determines whether the vehicle 100 is on the conveyor CV, using the vehicle position information and the conveyor position data PD indicating the building position of the conveyor CV in the factory FC.

In the case where it is determined in step S105 that the vehicle 100 is not on the conveyor CV, the target vehicle velocity decision process is ended. For example, in the case where the vehicle 100 is traveling on a portion that is of the traveling road TR and that is different from the partial traveling road TRp in step S105, the target vehicle velocity decision process is ended. In this case, the vehicle 100 continues the traveling on the traveling road TR, such that the target vehicle velocity is the first target velocity.

In the case where it is determined in step S105 that the vehicle 100 is on the conveyor CV, the target velocity acquisition unit 220 acquires the first target velocity of the vehicle 100, in step S110. In step S115, the conveyance velocity acquisition unit 230 acquires the conveyance velocity of the conveyor CV. Step S110 and step S115 may be executed before step S105, for example. Further, step S115 may be executed before step S110.

In step S120, the decision unit 240 calculates the second target velocity of the vehicle 100, based on the first target velocity acquired in step S110 and the conveyance velocity acquired in step S115. Then, the decision unit 240 decides that the target vehicle velocity of the vehicle 100 is the calculated second target velocity.

In step S120 in the embodiment, the decision unit 240 calculates the second target velocity by subtracting the conveyance velocity acquired in step S115 form the first target velocity acquired in step S110. Specifically, the second target velocity is defined by Expression (1) described below.

$${V}_{2} = {V}_{1} - {V}_{c} \cdot cos θ \qquad ( 1 )$$

In Expression (1), V₂ represents the magnitude of the second target velocity, V₁ represents the magnitude of the first target velocity, and V_{c} represents the magnitude of the conveyance velocity of the conveyor CV. Further, θ represents the angular difference between the conveyance direction TD and the target direction Dp. The angular difference θ is 0° when the conveyance direction TD and the target direction Dp coincide with each other, and is 180° when the conveyance direction TD and the target direction Dp are exactly opposite to each other.

The second target velocity, that is, the target vehicle velocity is not limited to a positive value, and can be a negative value or zero depending on the first target velocity and the conveyance velocity. In the embodiment, for example, in the case where the magnitude V₁ of the first target velocity is smaller than the magnitude V_{c} of the conveyance velocity because the angular difference θ is 0°, the target vehicle velocity is a negative value. In the embodiment, the positive target vehicle velocity means the target vehicle velocity that has the same direction as the target direction Dp, and the negative target vehicle velocity means the target vehicle velocity that has the opposite direction of the target direction Dp.

In step S125, the instruction unit 250 instructs the vehicle 100 such that the vehicle velocity of the vehicle 100 on the conveyor CV becomes the target vehicle velocity decided in step S120. That is, the instruction unit 250 instructs the vehicle 100 such that the vehicle velocity of the vehicle 100 on the conveyor CV becomes the second target velocity. Specifically, in step S125, the instruction unit 250 generates the traveling control signal for causing the vehicle 100 to travel at the second target velocity, and sends the generated traveling control signal to the vehicle 100. Using the received traveling control signal, the processor 111 of the vehicle 100 controls the actuator group 120 such that the vehicle 100 travels at the second target velocity. As a result, the vehicle 100 can move on the conveyor CV such that the actual velocity of the vehicle 100 becomes the first target velocity. For example, in the case where the first target velocity is higher than zero and where the second target velocity is a negative value, the vehicle 100, which travels such that the target vehicle velocity is the second target velocity, travels in the −X direction, which is the opposite direction of the target direction Dp, relative to the conveyor CV, but actually, the vehicle 100 moves in the +X direction, which is the same direction as the target direction Dp, in the global coordinate system GC. Further, in another embodiment, for example, by setting the first target velocity to zero, it is possible to cause the vehicle 100 to travel on the conveyor CV such that the vehicle 100 stays on the conveyor CV. That is, in this case, it is possible to cause the vehicle 100 to stay at the same position in the global coordinate system GC, with neither the forward movement nor the rearward movement on the moving conveyor CV.

In the above-described system 50 in the embodiment, when it is determined that the vehicle 100 is on the conveyor CV, the target vehicle velocity is decided based on the conveyance velocity of the conveyor CV. Accordingly, it is possible to decide an appropriate target vehicle velocity in consideration of the conveyance velocity of the conveyor CV, and to appropriately control the traveling of the vehicle 100 on the conveyor CV, using the decided target vehicle velocity.

Further, in the embodiment, the decision unit 240 calculates the second target velocity based on the first target velocity and the conveyance velocity, and decides that the target vehicle velocity is the calculate second target velocity. Thereby, it is possible to decide the target vehicle velocity based on the first target velocity. Accordingly, for example, by setting the first target velocity to a velocity suitable for a work that is executed to the vehicle 100 on the conveyor CV, it is possible to appropriately execute the work to the vehicle 100 on the conveyor CV.

Further, in the embodiment, the decision unit 240 calculates the second target velocity by subtracting the conveyance velocity from the first target velocity. Accordingly, it is possible to easily decide the target vehicle velocity based on the first target velocity.

Further, the embodiment includes the instruction unit 250 that instructs the vehicle 100 on the conveyor CV such that the vehicle velocity becomes the second target velocity. Accordingly, it is possible to instruct the vehicle 100 on the conveyor CV such that the traveling velocity of the vehicle 100 becomes the target vehicle velocity decided in consideration of the conveyance velocity of the conveyor CV.

### B. Second Embodiment

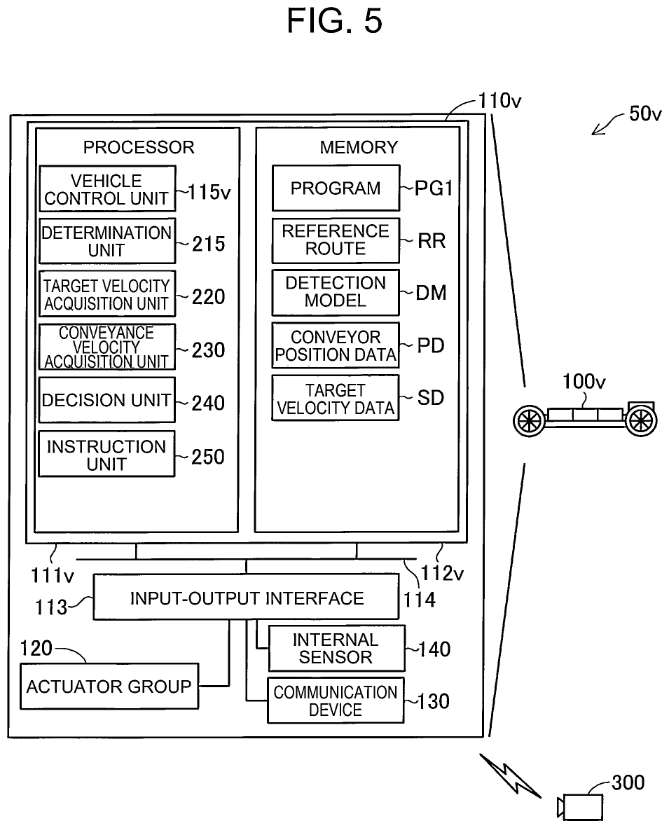

FIG. 5 is a block diagram showing the configuration of a system 50v in a second embodiment. The embodiment is different from the first embodiment, in that the system 50v does not include the server 200. Further, a vehicle 100v in the embodiment can travel by the autonomous control of the vehicle 100v. The other configuration is the same as that in the first embodiment, unless otherwise mentioned.

In the embodiment, a processor 111v of a vehicle control device 110v functions as a vehicle control unit 115v, the determination unit 215, the target velocity acquisition unit 220, the conveyance velocity acquisition unit 230, the decision unit 240, and the instruction unit 250, by executing a program PG1 stored in a memory 112v. The vehicle control unit 115v acquires detection results of sensors, generates the traveling control signal using the detection results, and outputs the generated traveling control signal to operate the actuator group 120. Thereby, the vehicle control unit 115v can cause the vehicle 100v to travel by the autonomous control. In the embodiment, the detection model DM, the reference route RR, the conveyor position data PD, and the target velocity data SD are previously stored in the memory 112v, in addition to the program PG1. The vehicle control device 110v in the second embodiment is an example of the “device” in the present disclosure.

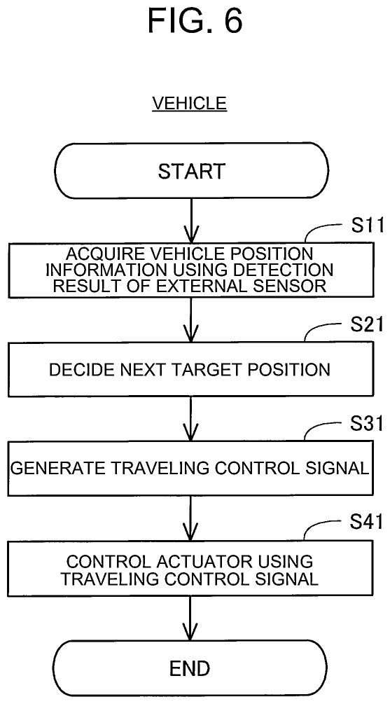

FIG. 6 is a flowchart showing a processing procedure of a traveling control for the vehicle 100v in the second embodiment. In the processing procedure in FIG. 6, the processor 111v of the vehicle 100v functions as the vehicle control unit 115v, by executing the program PG1.

In step S11, the processor 111v of the vehicle control device 110v acquires the vehicle position information, using the detection result output from the camera that is the external sensor 300. In step S21, the processor 111v decides the next target position to which the vehicle 100v will go. In step S31, the processor 111v generates the traveling control signal for causing the vehicle 100v to travel to the decided target position. In step S41, the processor 111v controls the actuator group 120 using the generated traveling control signal, and thereby, causes the vehicle 100v to travel in accordance with parameters that are shown in the traveling control signal. The processor 111v repeats the acquisition of the vehicle position information, the decision of the target position, the generation of the traveling control signal, and the control of the actuator group 120, in a predetermined cycle. With the system 50v in the embodiment, it is possible to cause the vehicle 100v to travel by the autonomous control of the vehicle 100v, even when the server 200 does not remotely control the vehicle 100v.

In the embodiment, the same process as the target vehicle velocity decision process in FIG. 4 is executed by the processor 111v of the vehicle 100v, at a predetermined time interval, for example. Further, each step in FIG. 4 is executed by the processor 111v. In step S110, for example, the target velocity acquisition unit 220 of the vehicle 100v may acquire the first target velocity included in the target velocity data SD that is previously stored in the memory 112v, or may acquire the first target velocity from a computer, a recording medium, or the like in the exterior of the vehicle control device 110v. In step S125, the instruction unit 250 of the vehicle 100 instructs the vehicle 100v such that the vehicle velocity of the vehicle 100v on the conveyor CV becomes the target vehicle velocity decided in step S120. Specifically, in step S125, the instruction unit 250 generates and outputs the traveling control signal for causing the vehicle 100v to travel at the target vehicle velocity. As a result, the actuator group 120 is controlled such that the vehicle 100v travels at the target velocity.

Also in the above-described system 50v in the second embodiment, it is possible to decide an appropriate target vehicle velocity in consideration of the conveyance velocity of the conveyor CV, and to appropriately control the traveling of the vehicle 100v on the conveyor CV, using the decided target vehicle velocity.

### C. Other Embodiments

(C1) In the above embodiments, the external sensor 300 is a camera. However, the external sensor 300 does not need to be a camera, and may be a light detection and ranging (LiDAR), for example. In this case, the detection result that is output by the external sensor 300 may be three-dimensional point cloud data that shows the vehicle 100. In this case, the server 200 or the vehicle 100 may acquire the vehicle position information by a template matching that uses the three-dimensional point cloud data as the detection result and previously prepared reference point cloud data.

(C2) In the first embodiment, the server 200 may acquire the vehicle position information using the detection result that is output from the internal sensor 140, in addition to or instead of the detection result that is output from the external sensor 300. In this case, for example, the server 200 may acquire the position as the vehicle position information, using the detection result of the vehicle velocity sensor, or may acquire the orientation as the vehicle position information, using the detection result of the gyroscope sensor. Further, the server 200 may acquire the vehicle position information using the detection result of the camera or the LiDAR as the internal sensor 140.

(C3) In the above embodiments, the decision unit 240 calculates the second target velocity based on the first target velocity and the conveyance velocity, and decides that the target vehicle velocity is the calculated second target velocity. However, the decision unit 240 does not need to decide the target vehicle velocity in this way, as long as the decision unit 240 decides the target vehicle velocity based on the conveyance velocity. In this case, for example, the decision unit 240 may decide the target vehicle velocity, by referring to a database in which the conveyance velocity and the target vehicle velocity are associated and stored, based on the acquired conveyance velocity. Further, in this case, the server 200 or the vehicle 100 does not need to include the target velocity acquisition unit 220.

(C4) In the first embodiment, the processes from the acquisition of the vehicle position information to the generation of the traveling control signal are executed by the server 200. However, at least some of the processes from the acquisition of the vehicle position information to the generation of the traveling control signal may be executed by the vehicle 100. For example, the following modes (1) to (3) may be adopted.

(1) The server 200 may acquire the vehicle position information, may decide the next target position to which the vehicle 100 will go, and may generate a route from the current place of the vehicle 100 that is shown in the acquired vehicle position information to the target position. The server 200 may generate a route to a target position between the current place and a destination, or may generate a route to the destination. The server 200 may send the generated route to the vehicle 100. The vehicle 100 may generate the traveling control signal such that the vehicle 100 travels on the route received from the server 200, and may control the actuator group 120 using the generated traveling control signal.

(2) The server 200 may acquire the vehicle position information, and may send the acquired vehicle position information to the vehicle 100. The vehicle 100 may decide the next target position to which the vehicle 100 will go, may generate the route from the current place of the vehicle 100 that is shown in the received vehicle position information to the target position, may generate the traveling control signal such that the vehicle 100 travels on the generated route, and may control the actuator group 120 using the generated traveling control signal.

(3) In the modes (1) and (2), for at least one of the generation of the route and the generation of the traveling control signal, detection results that are output from various internal sensors 140 may be used without being limited to the vehicle velocity sensor, the wheel velocity sensor, the gyroscope sensor, and the acceleration sensor. For example, in the mode (1), the server 200 may acquire the detection results of the internal sensors 140, and may reflect the detection results of the internal sensors 140 in the route at the time of the generation of the route. In the mode (1), the vehicle 100 may acquire the detection results of the internal sensors 140, and may reflect the detection results of the internal sensors 140 in the traveling control signal at the time of the generation of the traveling control signal. In the mode (2), the vehicle 100 may acquire the detection results of the internal sensors 140, and may reflect the detection results of the internal sensors 140 in the route at the time of the generation of the route. In the mode (2), the vehicle 100 may acquire the detection results of the internal sensors 140, and may reflect the detection results of the internal sensors 140 in the traveling control signal at the time of the generation of the traveling control signal.

(C5) In the second embodiment, for at least one of the generation of the route and the generation of the traveling control signal, detection results that are output from various internal sensors 140 may be used without being limited to the vehicle velocity sensor, the wheel velocity sensor, the gyroscope sensor, and the acceleration sensor. For example, the vehicle 100v may acquire the detection results of the internal sensors 140, and may reflect the detection results of the internal sensors 140 in the route at the time of the generation of the route. The vehicle 100v may acquire the detection results of the internal sensors 140, and may reflect the detection results of the internal sensors 140 in the traveling control signal at the time of the generation of the traveling control signal.

(C6) In the second embodiment, the vehicle 100v acquires the vehicle position information using the detection result of the external sensor 300. However, the vehicle 100v may acquire the vehicle position information using the detection result of the internal sensor 140, may decide the next target position to which the vehicle 100v will go, may generate the route from the current place of the vehicle 100v that is shown in the acquired vehicle position information to the target position, may generate the traveling control signal for the traveling on the generated route, and may control the actuator group 120 using the generated traveling control signal. In this case, the vehicle 100v can travel without using the detection result of the external sensor 300 at all. The vehicle 100v may acquire a target arrival time and congestion information from the exterior of the vehicle 100v, and may reflect the target arrival time and the congestion information in at least one of the route and the traveling control signal. Further, all functional compositions of the system 50v may be provided in the vehicle 100v. That is, the processes that are realized by the system 50v in the present disclosure may be realized by only the vehicle 100v.

(C7) The vehicle 100 may be manufactured by combining a plurality of modules. The module means a unit constituted by a plurality of components that is collected depending on a site or a function of the vehicle 100. For example, the platform of the vehicle 100 may be manufactured by combining a front module configuring a front portion of the platform, a central module configuring a central portion of the platform, and a rear module configuring a rear portion of the platform. The number of modules that constitute the platform is not limited to three, and may be two or less or may be four or more. Further, components constituting a portion of the vehicle 100 that is different from the platform may be modularized in addition to or instead of components constituting the platform. Further, various modules may include arbitrary exterior components such as a bumper and a grill, and arbitrary interior components such as a seat and a console. For example, such a module may be manufactured by joining a plurality of components by welding, a fixture, or the like, or may be manufactured by integrally molding at least some of components constituting the module, as one component, by casting. The molding technique for integrally molding one component, particularly a relatively large component is also called giga cast or mega cast. For example, the above front module, the above central module, and the above rear module may be manufactured by the giga cast.

(C8) The conveyance of the vehicle 100 using the traveling of the vehicle 100 by unmanned driving is also called “self-traveling conveyance”. Further, the configuration for realizing the self-traveling conveyance is also called “vehicle remote-control autonomous-traveling conveyance system”. Further, the production method of producing the vehicle 100 using the self-traveling conveyance is also called “self-traveling production”. In the self-traveling production, for example, at least a part of the conveyance of the vehicle 100 is realized by self-traveling conveyance, in the factory FC where the vehicle 10 is manufactured.

(C9) Some or all of functions and processes realized by software in the above embodiments may be realized by hardware. Further, some or all of functions and processes realized by hardware may be realized by software. As the hardware for realizing various functions in the above embodiments, for example, various circuits such as an integrated circuit and a discrete circuit may be used.

The present disclosure is not limited to the above-described embodiments, and can be realized as various configurations without departing from the spirit of the present disclosure. For example, technical characteristics in the embodiments that correspond to technical characteristics in the modes described in SUMMARY can be replaced or combined when appropriate, for solving some or all of the above-described problems or for achieving some or all of the above-described effects. Further, the technical characteristics can be removed when appropriate, except technical characteristics that are described to be essential in the present specification.

What is claimed is:

1. A device comprising:
a determination unit configured to determine whether a vehicle is on a conveyor, the vehicle being capable of traveling by unmanned driving;
a conveyance velocity acquisition unit configured to acquire a conveyance velocity of the conveyor; and
a decision unit configured to decide a target vehicle velocity of the vehicle based on the acquired conveyance velocity, when the determination unit determines that the vehicle is on the conveyor.

2. The device according to claim 1, further comprising a target velocity acquisition unit configured to acquire a first target velocity of the vehicle, wherein:
the decision unit is configured to calculate a second target velocity based on the acquired first target velocity and the acquired conveyance velocity; and
the decision unit is configured to decide that the target vehicle velocity is the calculated second target velocity.

3. The device according to claim 2, wherein the decision unit is configured to calculate the second target velocity by subtracting the conveyance velocity from the first target velocity.

4. The device according to claim 1, further comprising an instruction unit configured to instruct the vehicle such that a vehicle velocity of the vehicle becomes the target vehicle velocity, when the vehicle is on the conveyor.

5. A control method for a vehicle, comprising:
determining whether the vehicle is on a conveyor, the vehicle being capable of traveling by unmanned driving;
acquiring a conveyance velocity of the conveyor; and
deciding a target vehicle velocity of the vehicle based on the acquired conveyance velocity, when a determination unit determines that the vehicle is on the conveyor.

6. A device comprising a processor, wherein the processor is configured to execute:
determining whether a vehicle is on a conveyor, the vehicle being capable of traveling by unmanned driving;
acquiring a conveyance velocity of the conveyor; and
deciding a target vehicle velocity of the vehicle based on the acquired conveyance velocity, when determining that the vehicle is on the conveyor.
